(19) United States
(12) Patent Application Publication
(10) Pub. No.: US 2017/0136275 A1
(43) Pub. Date: May 18, 2017

(54) DEVICE, METHOD FOR ADVERTISING, METHOD FOR RETROFITTING A DEVICE, CONSTRUCTION SET AND ARRANGEMENT

(71) Applicant: URBANSITE VERWALTUNGS GMBH I.G., Düsseldorf (DE)

(72) Inventor: Christoph KRONHAGEL, Bonn (DE)

(21) Appl. No.: 15/321,117

(22) PCT Filed: Jun. 19, 2015
(86) PCT No.: PCT/DE2015/000300

§ 371 Date: Dec. 21, 2016

(30) Foreign Application Priority Data
Jun. 23, 2014 (DE) 10 2014 008 995.9
Jun. 26, 2014 (DE) 10 2014 009 291.7
Dec. 30, 2014 (DE) 10 2014 009 389.6
Apr. 15, 2015 (DE) 10 2015 004 636.5

(51) Int. Cl. A62C 3/16; G09F 27/00; G09F 9/33

(52) U.S. Cl. CPC A62C 3/16; G09F 9/33; G09F 27/005

(57) ABSTRACT

A device for displaying images or films includes a shell which is made of a translucent, flexible, air-tight and non-flammable material that delimits an interior space. The device further includes a fan for inflating the shell and a plurality of lights in the interior. A fire protection apparatus is provided which is configured to release a fire-extinguishing agent into the interior space if a fire is detected.

### TECHNICAL FIELD

Device, method for advertising, method for retrofitting a device, construction set and arrangement

The disclosure relates to a device for displaying images or films, a method for lighting and/or advertising by means of the device, a construction set for the device and an arrangement of the device.

### BACKGROUND

DE 20 2013 008 404 U1 discloses a device according to the preamble of claim 1 which is a portable lighting device with a translucent shell of a fabric or flexible plastic material, which is spanned by wires or cables between two carrying structures set at a distance from each other. The apparatus includes lighting means, and the shell can be used as a screen for pictures, motifs and moving images projected from inside. Fans mounted inside the device are designed to billow areas that are not fastened taut. The shell may be present as a web material which can be joined with a zip closure to form a tube. The shell may comprise A2 rated (non-combustible, with flammable portions) or B1 rated (flame-retardant) construction materials according to DIN 4102-1 and have an opacity that diffuses a high proportion of the light. The lighting means may be strung along the wires or ropes as LED strips, or the LED strips themselves can be used for the clamping.

All previously known media systems for displaying images or films, which may also contain text, of course, entail a fire loading for their installation site. The fire loading is the thermal potential of all combustible materials present in a given floor space correlated to said floor space. The calculated fire loading is the fire loading modified with corresponding coefficients fire loading and is used to determine the equivalent fire duration for a given fire loading or quantity and arrangement of combustible material. These in turn can be included in calculations to determine the required fire duration resistance of a building structure.

The fire loading associated with media systems often means that they cannot be installed in public places, in which the permissible fire loading is already exhausted, such as airport buildings. It is known from DE 202 18 388 U1 to install a smoke detector that can cut the power supply in a device for projecting light images on advertising surfaces, but this does not reduce the actual fire loading.

The situation becomes even more problematic for media systems that are lit from within, such as flat LED displays, the external walls of which are usually made of flammable plastic. In particular, the transilluminated front typically comprises a transparent, flammable plastic and cannot usually be replaced with fire-resistant glass, which would be extremely thick, for reasons of weight and cost alone.

### SUMMARY

The disclosure provides an easily transportable device for displaying images or films, having a shell made of a translucent, flexible, airtight and non-combustible material and a method for producing illumination and/or advertising that is suitable for satisfying the admissiblity requirements for public spaces.

This is achieved according to the disclosure by providing an apparatus for displaying images or films on a shell, the apparatus having a shell made from a translucent, flexible, and non-combustible material that delimits an interior space, a fan for inflating the shell and a plurality of outwardly directed lighting means in the interior space, wherein a firefighting device is provided that is configured to release an extinguishing agent in the interior space in the event that fire is detected. The disclosure also provides a method for illuminating and/or advertising by means of the apparatus wherein the fan is operated to keep the air in the interior space of the shell at a pressure larger than a pressure of the ambient air, wherein the lighting means are actuated to display text and/or moving images and/or static images, and/or to backlight texts and/or moving images and/or static images that are fixed to the shell statically or variably, wherein the interior space of the shell is monitored constantly for a fire, and if a fire is detected, the extinguishing agent is released into the inner space.

Advantageous further developments of the disclosure are described in the dependent claims.

Indefinite articles are each to be understood as “minimum” characteristics, unless otherwise indicated.

The fire protection system according to the disclosure, which liberates an extinguishing agent into the interior if a fire is detected, serves to render the device intrinsically safe. This means that the effective fire loading associated with the device at its installation site may be reduced to zero or even less than zero.

If a fire breaks out in the interior, this is achieved by corresponding dimensioning of the quantity of extinguishing agent that is held in readiness and available for release if a fire is detected. The quantity required for this is not very large in the inventive device, because practically all of the mechanical components can be made from non-combustible materials and essentially only the risk of fire due to the electrical and electronic systems and LEDs needs to be addressed. Also, fire originating externally cannot spread into the interior because of the non-combustible shell.

The extinguishing agent as such may be any commercially available extinguishing agent used in firefighting, but is preferably a quenching gas, which may be an inert gas, and still more preferably a chemically acting extinguishing agent, in particular a fluoroketone such as 3M™ Novec™ 1230 Fire Protection Fluid. Inside the inflated shell, the extinguishing agent easily reaches all parts, there would be no need of any means for distribution or the like.

Expediently, release of the extinguishing agent is not delayed until open flames exist, but instead is released as a preventive measure if one of one or more smoke detectors disposed inside the shell reports smoke generation.

In a preferred embodiment, the shell is made from one or more materials rated A1 according to DIN EN 13501-1 and/or DIN 4102-1, that is to say non-flammable with no combustible components. Because of the built-in fire protection system, the admissibility requirements for public spaces may possibly also be satisfied with shell materials of construction material class A2.

The material of the shell is preferably designed such that when inflated the shell assumes a defined shape, which is determined mainly by the cut of the shell material and to a lesser degree by the support structure and/or the air pressure in the interior, as is the case in the described prior art. In addition, the material of the shell should itself be such that light can pass through it but is diffused (translucent).

The inventors have discovered that there are suitable materials for the shell, which unlike the materials proposed in the described prior art meet all the aforementioned requirements. Particularly suitable is a textile containing glass fibres or other fibres that are non-flammable or very poorly flammable. Many such materials also have relatively low elasticity, so the inflated shell assumes a well-defined shape when inflated, and many such materials also have the advantage that they are translucent by nature.

All these features feature to a particularly high degree in fibreglass fabrics such as are used for fire blankets for example.

In a preferred embodiment, a plurality of lighting means, but not necessarily all, are attached to the inside of the shell, and not to any of the parts that support or span the shell, as in the cited prior art. Together, these lighting means form a pixel matrix with a curvature that matches the shape of the inflated shell. For this, the lighting means are relatively close to the shell, so that some of the heat from them escapes directly to the outside through radiation or heat conduction, thus further reducing the potential for fire.

The lighting means themselves may be of any kind, but in a preferred embodiment they have the form of a plurality of LED strips, particularly elongated flexible circuit boards, each of which is equipped with a plurality LEDs that are actuatable preferably individually or in groups, and of which the ends are equipped with connectors that can be non-destructively detached and re-connected for connection to each other and/or an activation electronic system.

In this context, each LED strip is supported in an elongated profile, the profiles being mounted side by side at small intervals on the shell and designed such that they keep all the LEDs at a defined distance from the shell, which distance is preferably the same everywhere and equal to a few millimetres, wherein the main beam of the LEDs is directed towards and through the shell. The distance between the LEDs and the shell that is maintained in this way thus remains constant, even if the shape of the inflated shell varies somewhat, due to air currents at the installation location, for example.

The profiles are preferably made of a soft, flexible, insulating material, particularly foam rubber or the like, and can be manufactured in an injection moulding process. Corresponding open or closed cell resilient foams are available in flame-retardant or non-combustible designs, as preferred for the present purposes. Because of the existing fire protection system, and because some of the waste heat from the LED strips passes directly through the closely located shell to the outside, it is sufficient if the profiles and LED strips are classified together in building material class B1.

The profiles are preferably fastened to the shell in such manner that they can be detached and re-connected non-destructively, e.g., by steel spring clips and/or blind rivets or by means of Velcro straps. Depending on the size of the device and the desired pixel resolution, more than 100, 200, 300), 400, 500 or 600 LED strips or profiles may be provided side by side inside the shell.

In a preferred embodiment, the profiles are made of a flexible, insulating material, but they may also comprise a more or less rigid material, such as aluminium, provided it can be ensured that they will not be permanently bent during transport. Optionally, such rigid profiles may be composed of several subsections, which are more or less loosely connected to each other by the ends thereof.

In a preferred embodiment, the shell is supported by a single support structure, which is arranged inside the shell, and not by two structures, as is the case in the cited prior art.

This embodiment is particularly suitable for suspended installation in a building, wherein the inflated shell or at least a concave shell section supporting the lighting means faces downwards.

The fire protection system including a smoke detector and all the necessary electrical and electronic systems including power supplies and LED actuation electronics can be arranged in the interior of the shell and attached to a support structure, and one or more air flaps opening to the outside and preferably also the fan may be integrated in the shell.

By making the shell parts and/or the lighting means non-destructively detachable and re connectable, the shell parts and/or lighting means can be replaced easily, so that the device can easily be retrofitted, repaired or serviced.

The various embodiments of the disclosure provide a compact, easily transportable construction set even for a device with very large spatial dimensions.

The disclosure is particularly suitable for arrangement inside a public transportation building, especially suspended in an overhead range above 2 m, 3 m, 4 m or 5 m, preferably in an airport building.

The disclosure provides a novel digital display for “Out of Home Media” which attracts particular attention in enclosed public places, particularly by means of a sculpted form, and radiates its media message with 360° visibility. The display is suspended in the room in such manner that its content is presented directly in front of people as they walk. Moving 360° images can revolve to reach everyone in the space. The content can alternate between advertising videos and messages from online magazines. Few people are able to ignore current news headlines. Accordingly, the viewer's gaze will also always register advertising, which may be constantly present in a backlit diapositive in a lower part of the device. The viewer can Learn more about messages or products by scanning a QR code at the lowest point of the device with his/her mobile end device, which causes him/her to look at the advertising again. Thus, the disclosure provides advertisers with novel presentation facilities at prominent locations and at the same time offers airports, railway stations and trade fairs attractive advertising space that can be creatively integrated in the existing architecture.

The demand for installations that meet the requirements of construction class A1 in these kinds of public spaces is growing. These requirements are fulfilled in a unique manner through intrinsic safety in the disclosure. This means that the device is associated with an effective fire loading of zero or even less than zero, and so corresponds to an item exclusively comprising A1 class construction materials, even though the device contains electrical and electronic systems. Due to the fire loading neutrality achieved in this way, there is nothing to prevent official approval for its use in buildings whose permissible fire loading has already been exhausted.

### BRIEF DESCRIPTION OF THE DRAWINGS

The following text is a description of exemplary embodiments with reference to the drawing. In the drawing:

FIG. 1 is a cross section through a device for displaying images or films according to the disclosure;

FIG. 2A is a plan view of a barrel-shaped section of the shell of the device of FIG. 1;

FIG. 2B is a side view of the barrel-shaped section of the shell in FIG. 2A;

FIG. 3 is a perspective view of a plurality of segments of the barrel-shaped section of FIGS. 2A and 2B;

FIG. 4A is a cross section through a profile for holding an LED strip;

FIG. 4B is a perspective view of the profile of FIG. 4A, with a LED tape attached therein;

FIG. 4C is a perspective view of consecutively arranged profiles as shown in FIG. 4B, of which the LED strips are connected to each other by plug connectors;

FIG. 5 is a cross section through a profile similar to that of FIGS. 4A and 4B, which is fastened to the shell of the device by means of blind rivets and steel spring clips;

FIG. 6 is a cross section through three parallel profiles in a shell to explain a further alternative profile attachment;

FIG. 7 is a side view and plan view of a steel spring clip for an alternative profile fastening; and

FIG. 8 is a cross section through a differently shaped profile for supporting a LED strip.

### DETAILED DESCRIPTION OF THE DRAWINGS

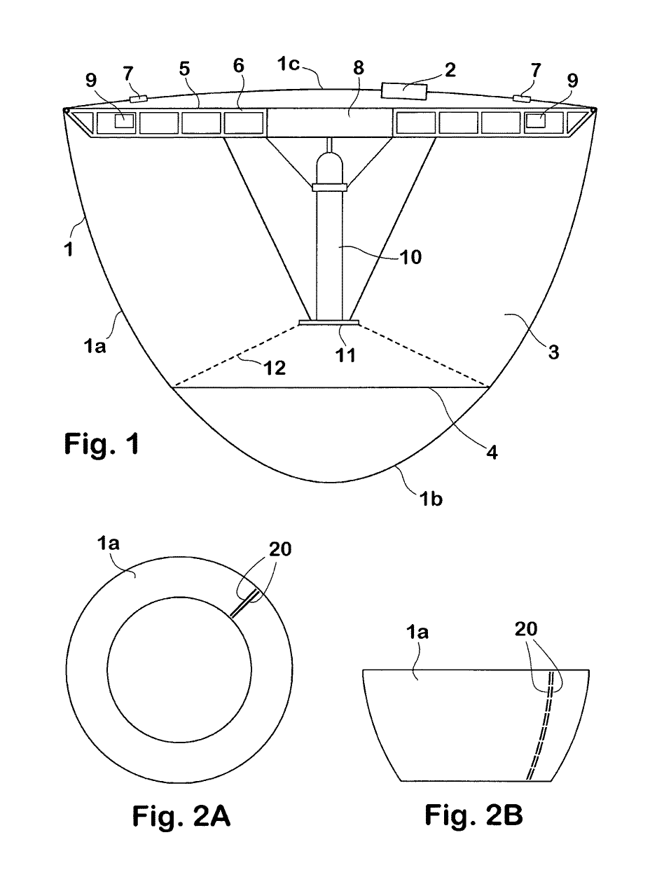

The device shown in FIG. 1 for displaying images or films includes a shell 1 made from a glass fibre fabric that is translucent while scattering light diffusely, airtight, non-combustible and flexible but with low stretching properties,

Shell 1 is essentially closed air-tight and is inflated by a fan 2 into the shape of a balloon, which is the surface of a concave rotational body whose central axis is vertical in FIG. 1. Shell 1 delimits an interior space 3. The balloon shape may have a diameter of several metres, e.g., 6 metres.

Shell 1 includes a barrel-shaped section 1a, which in particular has the form of an axial section of a barrel from approximately the centre thereof to a point close to one of its ends. At its lower, narrower end, barrel-shaped section 1a transitions into a spherical, cap-shaped section 1b without any abrupt change in curvature, and this section closes the narrower end of barrel section 1a. The other, upper end of barrel-shaped section 1a is sealed with a shallow concave section 1c. Sections 1a, 1b, and 1c which make up shell 1, are connected to each other along their connecting lines 4, 5 by zip fasteners (not shown).

Shell 1 is supported by a supporting structure 6, which is a disc-shaped lightweight tubular and may be assembled from a plurality of angled segments, e.g., from twelve identical angled segments that are bolted together for easy transport. Supporting structure 6 is suspended from a ceiling or false ceiling structure of a building by means of three ropes (not shown), which together with a power cable can pass through narrow openings in the flat concave section 1c of shell 1.

Supporting structure 6 is located entirely within shell 1 and extends all in all directions to a distance close to the ring-shaped zip fastener 5 between barrel-shaped section 1a and shallow concave portion 1c and may be connected to one of these sections there. Thus, supporting structure 6 also contributes to the shaping of shell 1, although its balloon shape is determined primarily by the cut of shell 1 and its components.

The upper, shallow concave portion 1c of shell 1 does not have to be made from the same material as sections 1a and 1b of shell 1, but can also comprise a different, air-impermeable, non-flammable, flexible material. Upper section 1c might also be formed by supporting structure 6 itself, if the structure constructed in any manner that is impermeable to air and can be combined with sections 1a, 1b of shell 1 to enclose interior space 3 in airtight manner.

Fan 2 is an inline duct fan which is integrated in the shallow concave section 1c of shell 1, that is to say it is built into said section and supported thereon. Fan 2 might alternatively be fixed to supporting structure 6 and connected to a corresponding opening in section 1c of shell 1 via a bellows, for example.

Several ventilation flaps 7 are also integrated in the shallow concave portion 1c of shell 1, and open onto outwards in the manner of check valves when a predetermined air pressure in the interior space 3 of shell 1 is exceeded, so that a defined air pressure is established in interior space 3 of shell 1, which is slightly greater than the pressure of the ambient air, when the fan 2 is running, thereby generating and stabilising the balloon shape of shell 1.

Space for the electrical and electronic systems needed for the operation of the device is provided in a centre 8 of supporting structure 6, and LED activation electronics 9 are separate therefrom and mounted closer to the outer edge of supporting structure 6.

An extinguishing gas generator 10 located in interior space 3 is mounted below centre 8 on supporting structure 6, and when any of one or more smoke detectors (not shown) in interior space 3 is activated, it releases a quenching gas, preferably 3M™ Novec™ 1230 Fire Protection Fluid, but this may also be an inert gas, for example.

A platform 11 is mounted on supporting structure 6 below quenching gas generator 10, on the underside of which platform a floodlight (not shown) comprising a plurality of LEDs or other lighting means is fixed, and provides uniform backlighting for the spherical cap portion 1b within a cone 12. The spherical cap portion 1b may be furnished with text and/or images that are rendered clearly visible by the backlighting, and when the advertiser using the surfaced changes, section 1b may be replaced particularly easily.

Barrel-shaped section 1a of shell 1 is shown smaller in FIGS. 2A and 2B than in FIG. 1. A plurality of LED strips 20 are attached to the inside of barrel-shaped section 1a of shell 1, and extend equidistantly from each other from one axial end of barrel section 1a to the other, only two of which are shown in FIGS. 2A and 2B, whereas in fact many LED strips 20 arranged sided by side, in this example 600 LED strips 20, are distributed over the entire circumference of barrel-shaped section 1a.

In FIG. 2B, the LED strips 20 are shown by dashed lines because the glass fibre fabric preferred for shell 1 is so opaque that LED strips 20 are barely visible from the outside when they are not lit. Groups of several LED strips 20 may each have a controller, which is located in a pocket sewn into the upper edge of section 1a of shell 1 and is connected to one of the activation electronic systems 9 on supporting structure 6 by plug connectors.

Fan 2 and the air flaps 7 are designed such that fan 2 always blows some air into interior space 3, which cools the electrical and electronic systems, the LED activation electronics 9 and LED strips 20, and escapes to the outside again through air flaps 7 to dissipate the residual heat.

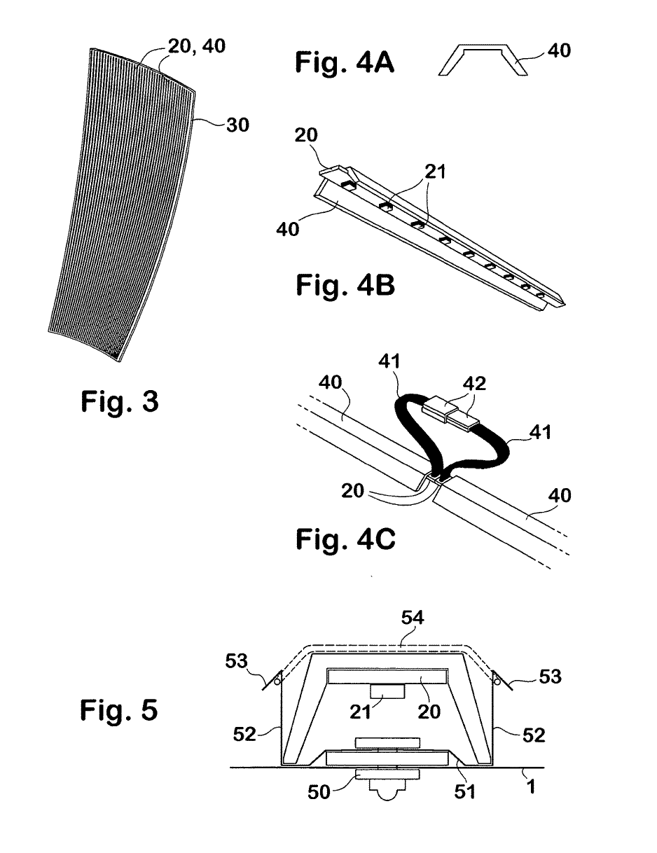

Barrel-shaped section 1a of shell 1 can be assembled from a plurality of radial segments 30, one of which is shown in FIG. 3 in perspective together with the attached LED strips 20. The edges of segments 30 may be provided with zip fastening elements, so that they can be joined to each other and with the other sections 1b and 1c of shell 1, which are furnished with corresponding zip fastening elements.

LED strips 20 are elongated, flexible circuit boards, each furnished with many, preferably individually actuatable LEDs 21 (FIG. 4B). LEDs in various colours such as red, green and blue can be arranged one behind the other alternately or in groups, or the individual LEDs may be multicoloured.

When shell 1 is inflated, barrel-shaped section 1a of shell 1 and LED strips 20 form a uniform round video surface that can show 360° panoramic images. After fan 2 is switched off, shell 1 30 can be disassembled into its sections 1a, 1b, 1c and segments 30, which can be folded up to save space for transport and storage without having to remove the LED strips 20 thereon.

Each LED strip 20 is supported by an approximately equally long elongated profile 40, which is shown in FIG. 4A individually in cross section and in perspective in FIGS. 4B and 4C together with an LED strip 20 inserted in each. In this embodiment, profiles 40 are made of foam rubber, but they may also comprise a different, more or less flexible material which as far as possible should also be electrically insulating. In this example, LED strip 20 is attached adhesively inside profile 40, either directly or by means of double-sided tape, but it may also be secured to profile 40 in another way, e.g., by form-fitting.

Profiles 40 are mounted side by side at small intervals from each other on shell 1 or on each shell segment 30 and are designed such that they hold the LED strips 20 inserted in the profiles 40 and therewith the associated LEDs 21 at a defined distance from shell 1, wherein the main beam of LEDs 21 is directed towards and through shell 1. The LEDs 21 are such that have relatively large radiation angles, and the distance between the LEDs 21 of shell 1 is measured in a few millimetres so that each LED 21 lights a single spot on shell 1, which spot is many times larger area than the emitting surface of LED 21 itself.

LED strips 20 may not be available in a height corresponding to shell 1 or a length corresponding to the shell segments 30. However, several commercially available LED strips 20, which are each supported by an equally long profile 40, may be connected one after the other by joining them with ribbon cables 41 and plug connectors 42, as shown in FIG. 4C.

Profiles 40 are fastened side by side at small intervals from each other on shell 1 or on shell segments 30, as illustrated in FIGS. 2 and 3. The fastening means might be an adhesive connection, for example, but non-destructively detachable and re-connectable fixtures make it possible to replace individual profiles 40 in the event of failure of a LED strip 20 therein, for example. Some ways to mount the profiles 40 replaceably to shell 1 are described in the following.

One option for fastening profiles 40 so that they can be detached and re-connected non-destructively is shown in FIG. 5. Blind rivets 50 are inserted at intervals in shell 1, each having a clip 51 made of spring steel wire which is bent such that profile 40 with the inserted LED strip 20 fits two legs 52 of clip 51, wherein it is fastened to shell 1 with a rubber ring 54 that encircles angled ends 53 of clip 51.

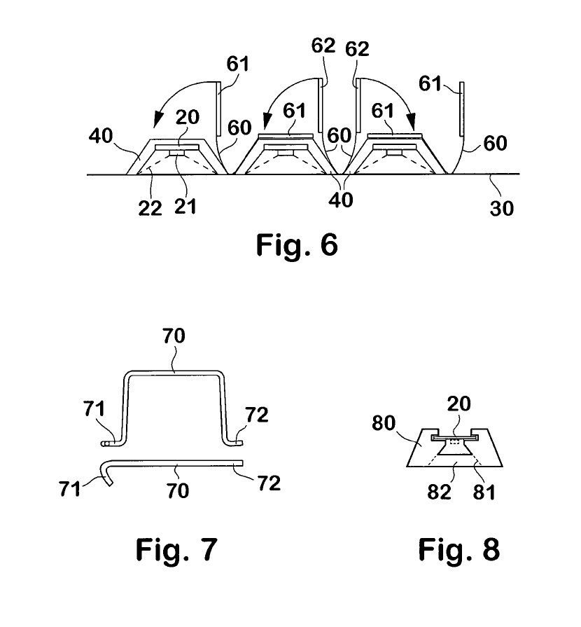

Another option for fastening profiles 40 so that they can be detached and re-connected non-destructively is shown in FIG. 6. For this purpose, textile strips 60 are sewn to the inside of shell segments 30 of section 1a of shell 1 at regular intervals corresponding to the profile distance, and are provided with hook and loop tapes 61 and Velcro strips 62 which are stapled together behind profiles 40, as illustrated in FIG. 6 by arrows.

Textile strips 60, the Velcro fasteners 61, 62 and the yarn used all conform to construction materials class A1, so that the connection of profiles 40 to shell 1 is also fireproof.

The emission cone 22 of LEDs 21 is also indicated by dashed lines in FIG. 6. The pronounced flaring of emission cone 22 and the emission characteristics of typical wide-angle LEDs result in the projection of optically soft pixels on the shell, so that the viewer has the impression of a homogeneous video image despite small gaps between the pixels.

Another option for fastening profiles 40 so that they can be detached and re-connected non-destructively is shown in FIG. 7. For this purpose, clips 70 made of spring steel wire are provided and placed over the profiles 40 and the bent ends 71 and 72 thereof are pushed under seams (not shown), which are sewn at regular intervals to the insides of shell segments 30.

In order to produce the sections 1a, 1b, 1c which are curved in two spatial directions and the segments 30 of shell 1, marks for cutting and placing the profiles 40 are made on fabric webs by a plotter, the webs are then cut to size and shape and sewn together and then laid out on a large table. Profiles 40 are fastened along the corresponding markings, and LED strips 20 are also inserted therein. Then, the individual parts can be rolled up parallel with the profiles or folded together and transported to their mounting location, where they can be joined together around supporting structure 6 by means of the zip fasteners.

The shape of the profiles 40 shown in FIGS. 1 to 6 for supporting LED strips 20 is just one example thereof, other profile shapes can also be used. FIG. 8 shows an example of a somewhat differently shaped profile 80, which engages in form fitting manner around an LED strip 20. In this way, LED strip 20 is easily connectable to profile 80, either by pushing in or by sliding lengthwise, and can easily be removed in the same way.

The profile 80 shown in FIG. 8 also does not have a long, continuous groove on the light emitting side of LED strip 20 like the profile 40 described previously, but instead contains individual cone-shaped holes 81 for the passage of light, one for each light-emitting diode, wherein a foam rubber web 82 remains extending lengthwise between each of two holes 81.

1. A device for displaying images or films, the device having a shell made from a translucent, flexible, and non-combustible material that delimits an interior space, a fan for inflating the shell and a plurality of lighting means in the interior space, wherein a firefighting device is provided that is configured to release an extinguishing agent in the interior space in the event that fire is detected.

2. The device according to claim 1, wherein the device is intrinsically safe.

3. The device according to claim 1, wherein the extinguishing agent is an extinguishing gas or a chemically acting fire extinguishing agent.

4. The device according to claim 1, wherein the shell comprises one or more materials with construction material rating A1 according to DIN EN 13501-1 and/or DIN 4102-1.

5. The device according to claim 1, wherein the material of the shell is such that the shell is configured to adopt a defined shape in the inflated state, which is determined mainly by the cut of the shell material.

6. The device according to claim 1, wherein the material of the shell is translucent with a diffusing, scattering effect of light.

7. The device according to claim 1, wherein the material of the shell is a textile comprising glass fibres or other fibres that are entirely or practically non-combustible.

8. The device according to claim 1, wherein a plurality of lighting means are fastened to the inside of the shell and together form a pixel matrix having a curvature that corresponds to the shape of the inflated shell.

9. The device according to claim 1, wherein the lighting means comprise a plurality of LED strips, wherein each LED strip is supported in an elongated profile, the plurality of profiles being fastened closely side by side to the shell and configured to hold all LEDs of the plurality of LED strips at a defined distance from the shell, wherein the main beam of the LEDs is directed towards and through the shell.

10. The device according to claim 9, wherein the elongated profiles are made of a flexible, insulating material.

11. The device according to claim 9, wherein the elongated profiles are fastened to the shell such that the elongated profiles are configured to detach from and re-connect to the shell non-destructively.

12. The device according to claim 9, wherein more than 100 LED strips or elongated profiles are provided in the shell and positioned side by side.

13. The device according to claim 1, wherein the shell is supported by a single supporting structure disposed in the interior space of the shell.

14. The device according to claim 1, wherein the supporting structure is configured for suspended attachment in a building, wherein the inflated shell or at least a concave shell section thereof supports a plurality of lighting means faces downwards.

15. The device according to claim 1, wherein the fire protection device includes a smoke detector, and a plurality of electrical and electronic systems including a plurality of power supplies and LED activation electronics arranged in the interior space of the shell and fastened to the one or more supporting structures, and one or more air flaps open to the outside and the fan are integrated in the shell.

16. A method for illuminating and/or advertising by means of a device, in particular a device according to claim 1, for displaying images or films on an shell made of a translucent, flexible, airtight and non-combustible material, which delimits an interior space, having a fan for inflating said shell and a variety of outwardly directed lighting means in the interior space, which are secured in a pixel matrix on the inside of the shell and supported thereby, wherein the fan is operated to keep the air in the interior space of the shell at a pressure larger than a pressure of the ambient air, wherein the lighting means are actuated to display text and/or moving images and/or static images, and/or to backlight texts and/or images that are fixed to the shell statically or variably, and wherein the interior space of the shell is monitored constantly for a fire, and if a fire is detected, the extinguishing agent is released into the inner space.

17. The method for retrofitting a device according to claim 16 by replacing one or more shell sections and/or lighting means configured to detach and re-connect non-destructively.

18. A construction set for a device according to claim 1.

19. An arrangement of the device according to claim 1 in the interior of a public transport building, particularly in an overhead area above 2 m, 3 m, 4 m or 5 m.
